(19) United States
(12) Patent Application Publication
(10) Pub. No.: US 2023/0402707 A1
(43) Pub. Date: Dec. 14, 2023

(54) BATTERY SYSTEM HOUSING AND BATTERY SYSTEM HAVING THE SAME

(71) Applicant: HYUNDAI MOBIS CO., LTD., Seoul (KR)

(72) Inventors: Ju Hwan KIM, Yongin-si (KR); Se Yoon PANG, Yongin-si (KR)

(73) Assignee: HYUNDAI MOBIS CO., LTD., Seoul (KR)

(21) Appl. No.: 18/082,105

(22) Filed: Dec. 15, 2022

(30) Foreign Application Priority Data
Jun. 14, 2022 (KR) 10-2022-0072238

(51) Int. Cl. H01M 50/383; H01M 50/264; H01M 50/293

(52) U.S. Cl. CPC H01M 50/383; H01M 50/264; H01M 50/293

(57) ABSTRACT

A housing for a battery system is provided including a case in which a plurality of battery modules are arranged and fixed and is configured to have an open upper part, a cover configured to cover the open upper part of the case, and a partition wall disposed between the cover and the plurality of battery modules, and configured to block a flame generated in any one of the plurality of battery modules from spreading to other adjacent battery modules.

### CROSS-REFERENCE TO RELATED APPLICATION

This application claims the benefit of under 35 USC § 119(a) of Korean Patent Application No. 10-2022-0072238, filed on Jun. 14, 2022, in the Korean Intellectual Property Office, the disclosure of which is incorporated herein by reference in its entirety for all purposes.

### BACKGROUND

### 1. Field

The following description relates to a battery housing system and a battery system having the same, and more particularly, to a housing for a battery system that can prevent a fire from spreading and a battery system having the same.

### 2. Description of the Related Art

Lithium-ion batteries with high energy density are mainly used in batteries for electric vehicles and energy storage systems (ESS). However, compared to other batteries, lithium-ion batteries are vulnerable to fire.

In general, thermal runaway occurs when an internal temperature of a lithium-ion battery is 170° C. or higher. Therefore, even when a problem occurs in one battery module BM as shown in FIG. 1, a fire F spreads to all battery modules BM in an instant.

In order to prevent the fire from spreading, technology development is being made on a method of shutting off power through a sensor, etc., or providing a fire extinguishing device outside the battery.

However, this is difficult to apply to electric vehicles because the weight and volume of a device or structure for preventing the fire from spreading are large, thereby lowering the efficiency of electricity consumption of the electric vehicles and causing an increase in cost.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, here is provided a housing for a battery system including a case in which a plurality of battery modules are arranged and fixed and is configured to have an open upper part, a cover configured to cover the open upper part of the case, and a partition wall disposed between the cover and the plurality of battery modules, and configured to block a flame generated in any one of the plurality of battery modules from spreading to other adjacent battery modules. The partition wall may be provided in a structure extending downward from a bottom surface of the cover toward upper surfaces of the plurality of battery modules.

The partition wall may be configured to have a lattice-shaped structure corresponding to an arrangement of the plurality of battery modules arranged in a horizontal direction and a vertical direction, and may be disposed in a closed-loop shape corresponding to a periphery of an upper surface edge of a corresponding battery module on an upper part of each battery module of the plurality of battery modules.

An interference-preventing gap may be provided between a bottom surface of the partition wall and the upper surfaces of the plurality of battery modules.

The partition wall may be insert-molded on the bottom surface of the cover to be provided in an integrated structure.

The partition wall may be made of a flame-retardant plastic, and the housing may also include an expanded graphite sheet attached to a bottom surface of the partition wall.

A fire-retardant paint may be applied to an inner side surface of the partition wall.

The partition wall may be provided in a structure extending upward from the upper surfaces of each of the plurality of battery modules toward a bottom surface of the cover.

The partition wall may further include a base disposed on the upper surfaces of each of the plurality of battery modules, and may be disposed in a structure extending upward from a periphery of an edge of the base, and the partition wall and the base may be made of a flame-retardant plastic.

The partition wall may include a locking hook, which is locked and fixed to a locking groove provided in a side surface of each of the plurality of battery modules at a bottom end of the partition wall and a locking protrusion, which is placed on the upper surfaces of each of the plurality of battery modules, at an upper part of the locking hook, and may be disposed in a structure extending above the upper surface of the battery module from an upper side surface of the battery module.

A fire-retardant paint may be applied to an inner side surface of the partition wall and an upper surface of the partition wall.

An interference-preventing gap may be provided between an upper surface of the partition wall and the bottom surface of the cover.

The partition wall may be made of a flame-retardant plastic having a char (bubble-shaped carbide) production amount of 10 to 40%.

In another general aspect here is provided a battery system including a plurality of battery modules and a housing including a case having an open upper part and configured to accommodate the plurality of battery modules, a cover configured to cover the open upper part of the case, and a partition wall disposed between the cover and the plurality of battery modules, and the partition wall may be configured to block a flame generated in any one of the plurality of battery modules from spreading to other adjacent battery modules.

### BRIEF DESCRIPTION OF THE DRAWINGS

FIG. 1 is a view schematically illustrating a state in which a flame is spread in a typical battery system.

FIG. 2 is an exploded perspective view schematically illustrating a battery module in a battery system in accordance with one or more embodiments.

FIG. 3 is a plan view schematically illustrating a state in which battery modules are arranged in the battery system in accordance with one or more embodiments.

FIG. 4A is a view schematically illustrating a cross section along line I-I in FIG. 3.

FIG. 4B is a view schematically illustrating a cross section along line II-II in FIG. 3.

FIG. 5 is a bottom view schematically illustrating a cover provided with partition walls in the battery system in accordance with one or more embodiments.

FIG. 6 is a view schematically illustrating a cross section along line A-A in FIG. 3.

FIG. 7 is a view schematically illustrating a battery system provided with a partition wall in accordance with one or more embodiments.

FIG. 8 is a view schematically illustrating another example of a partition wall.

FIG. 9 is a block diagram illustrating a method of performing a flame test on the partition wall.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Advantages and features of the present disclosure and methods of achieving the advantages and features will be clear with reference to embodiments described in detail below together with the accompanying drawings. However, the present disclosure is not limited to the embodiments disclosed herein but will be implemented in various forms. The embodiments of the present disclosure are provided so that the present disclosure is completely disclosed, and a person with ordinary skill in the art can fully understand the scope of the present disclosure. The present disclosure will be defined only by the scope of the appended claims. Meanwhile, the terms used in the present specification are for explaining the embodiments, not for limiting the present disclosure.

Terms, such as first, second, A, B, (a), (b) or the like, may be used herein to describe components. Each of these terminologies is not used to define an essence, order or sequence of a corresponding component but used merely to distinguish the corresponding component from other component(s). For example, a first component may be referred to as a second component, and similarly the second component may also be referred to as the first component.

Throughout the specification, when a component is described as being “connected to,” or “coupled to” another component, it may be directly “connected to,” or “coupled to” the other component, or there may be one or more other components intervening therebetween. In contrast, when an element is described as being “directly connected to,” or “directly coupled to” another element, there can be no other elements intervening therebetween.

In a description of the embodiment, in a case in which any one element is described as being formed on or under another element, such a description includes both a case in which the two elements are formed in direct contact with each other and a case in which the two elements are in indirect contact with each other with one or more other elements interposed between the two elements. In addition, when one element is described as being formed on or under another element, such a description may include a case in which the one element is formed at an upper side or a lower side with respect to another element. \

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

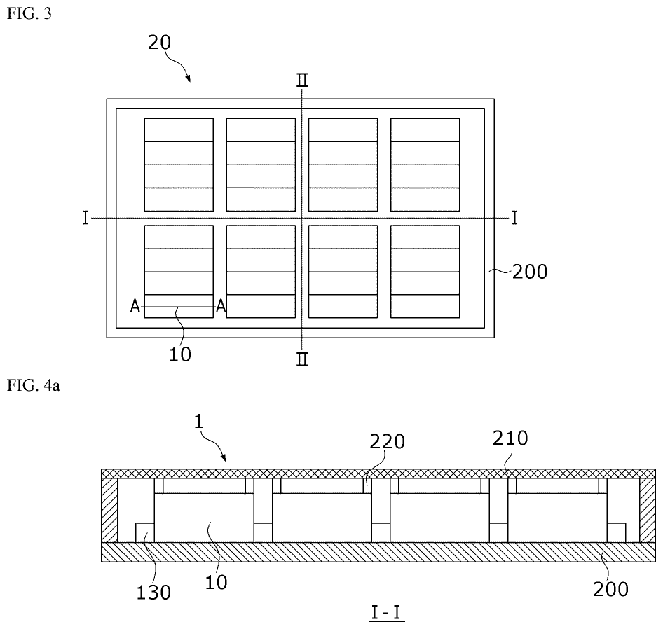

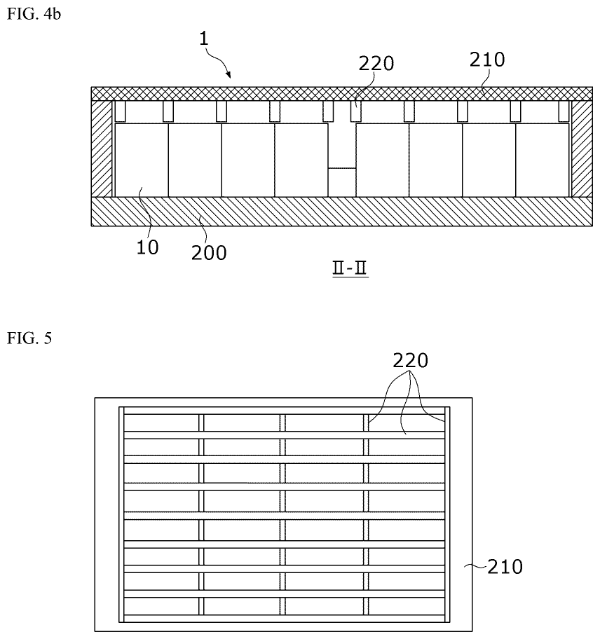

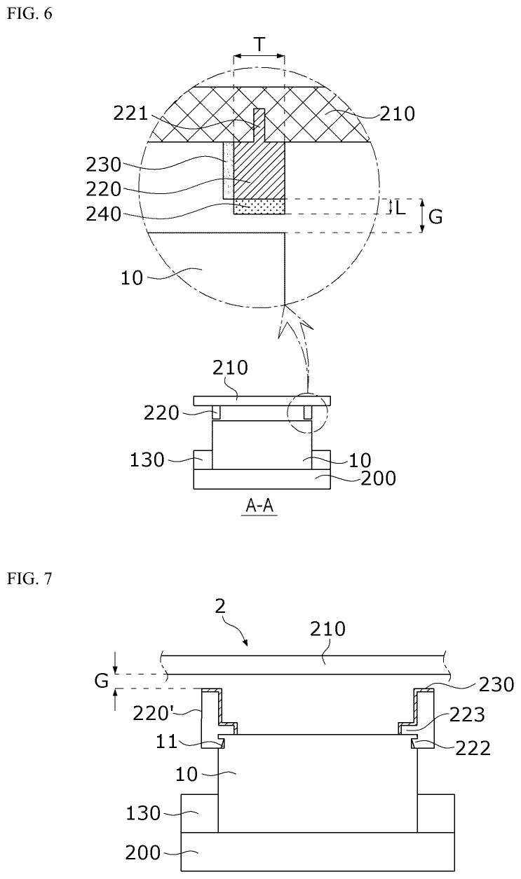

FIG. 2 is an exploded perspective view schematically illustrating a battery module in a battery system according to an exemplary embodiment of the present disclosure, FIG. 3 is a plan view schematically illustrating a state in which battery modules are arranged in the battery system according to the exemplary embodiment of the present disclosure, FIG. 4A is a view schematically illustrating a cross section along line I-I in FIG. 3, and FIG. 4B is a view schematically illustrating a cross section along line II-II in FIG. 3. FIG. 5 is a bottom view schematically illustrating a cover provided with a partition wall in the battery system according to the exemplary embodiment of the present disclosure, and FIG. 6 is a view schematically illustrating a cross section along line A-A in FIG. 3.

Referring to the drawings, a battery system 1 according to an exemplary embodiment of the present disclosure may include a plurality of battery modules 10 and a housing 20 accommodating the battery modules 10.

Each of the battery modules 10 may include a stacked structure 100 formed by stacking a plurality of pouch-type battery cells 101 in a horizontal direction, and end plates 110 are respectively disposed on both sides of the stacked structure 100 in a width direction to protect the stacked structure 100. In the exemplary embodiment, the end plates 110 may be made of a galvanized steel sheet.

In addition, a module cover 120 is disposed on an upper part of the stacked structure 100, and the module cover 120 may be configured such that both ends are bonded to the end plates 110, respectively, to protect the stacked structure 100 in connection with the end plates 110. In the exemplary embodiment, the module cover 120 may be made of a lightweight plastic.

In addition, bus bar assemblies 130 configured to bond and electrically connect electrodes of the battery cell 101 to each other may be disposed on front and rear sides, that is, on both sides in a longitudinal direction of the stacked structure 100, respectively.

The plurality of battery modules 10 may be arranged and provided in the horizontal and vertical directions, and may be accommodated and fixed in the housing 20 for a battery system.

The housing 20 may support the plurality of battery modules 10 accommodated therein and protect the battery modules 10 from an external environment.

Referring to the drawings, the housing 20 may include a case 200 having an open upper part and accommodating the plurality of battery modules 10, a cover 210 that covers the open upper part of the case 200, and a partition wall 220 disposed between the cover 210 and the plurality of battery modules 10.

The case 200 may have an inner space and a box-shaped structure having an open upper part. The plurality of battery modules 10 may be placed in the case 200 to be supported and fixed, and may be disposed in the horizontal and vertical directions in the inner space to form a plurality of columns and rows.

In the exemplary embodiment, the case 200 may be made of a metal material having rigidity. However, the material of the case 200 is not limited thereto.

The cover 210 is provided to cover the open upper part of the case 200, and may be disposed on the upper part of the plurality of battery modules 10 in a state of being spaced apart from the plurality of battery modules 10.

The cover 210 may protect the plurality of battery modules 10 together with the case 200 by blocking the exposure of the plurality of battery modules 10 to the outside.

In the exemplary embodiment, the cover 210 may be made of a metal material having rigidity to seal the battery module 10 and support the partition wall 220 that will be described below. For example, the cover 210 may be made of a galvanized steel sheet having a thickness of 0.5 mm to 1.0 mm.

The partition wall 220 is disposed between the cover 210 and the plurality of battery modules 10, and may prevent a flame generated in any one of the plurality of battery modules 10 from spreading to other adjacent battery modules 10 through a space between the cover 210 and the battery module 10.

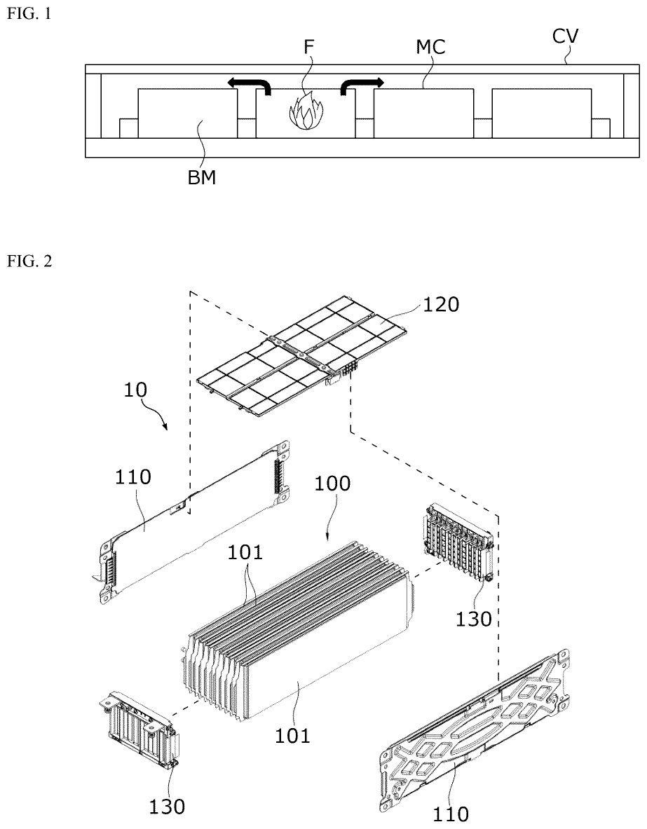

As shown in FIG. 1, in the case of a pouch-type battery module BM, when a flame F occurs, an upper thin plastic module cover MC is easily burned up, and the flame F expanded therethrough is spread to adjacent battery modules BM along a space provided between the battery module BM and the cover CV.

The partition wall 220 according to this exemplary embodiment may prevent the flame from spreading between the battery modules 10 by being disposed in the space between the battery module 10 and the cover 210, and may secure enough time for passengers in an electric vehicle to escape by suppressing the spread of the flame. That is, the partition wall 220 may function as a fire wall.

Referring to the drawings, the partition wall 220 may be provided in a structure extending downward from a bottom surface of the cover 210 toward upper surfaces of the plurality of battery modules 10.

In addition, the partition wall 220 has a lattice-shaped structure corresponding to an arrangement of the plurality of battery modules 10 arranged in the horizontal and vertical directions to be located on the upper part of each battery module and may be disposed in a closed-loop shape corresponding to the periphery of an upper surface edge of the corresponding battery module 10 on the upper part of each battery module 10. That is, the partition wall 220 may be disposed along the periphery of the upper surface edge of each battery module 10 and provided in a structure facing the upper surface edge of the corresponding battery module 10.

In the exemplary embodiment, the partition wall 220 may be insert-molded on the bottom surface of the cover 210 to be provided in an integrated structure. In this case, the partition wall 220 may be firmly fastened to the cover 210 by inserting and fixing a coupling anchor protrusion 221 formed on the upper surface of the partition wall into the cover 210. This fastening structure may prevent the partition wall 220 from being separated from the cover 210 by vibration and impact.

In the exemplary embodiment, the partition wall 220 may be made of a flame-retardant material. The flame-retardant material may include, for example, a flame-retardant plastic containing 10 to 30% of glass fiber (GF) such as PP, MPPO, PA6, or the like. In addition, the flame-retardant plastic may be designed to have a char (bubble-shaped carbide) production amount in a range of 10 to 40%. When the char production amount is less than 10%, an insulation effect decreases, and when it exceeds 40%, the insulation effect increases but structural rigidity as a component is lost. That is, the component is structurally damaged by a pressure caused by a flame, thereby losing an effect of preventing thermal runaway.

A thickness T in the width direction of the partition wall 220 may be set in consideration of formability and flame suppression performance. In the exemplary embodiment, when the partition wall 220 is made of MPPO, the thickness T may be designed in a range of 2.5 mm to 3.0 mm. In addition, when the partition wall 220 is made of PP, the thickness T may be designed in a range of 1.5 mm to 3.0 mm. In addition, when the partition wall 220 is made of PA6, the thickness T may be designed in a range of 2.0 mm to 3.0 mm.

In the exemplary embodiment, a fire-retardant paint 230 may be applied to an inner side surface of the partition wall 220. The fire-retardant paint 230 includes an epoxy-based intumescent flame-retardant paint, and one having the characteristics of exhibiting optimal performance at an expansion start temperature of 200° C. and an expansion rate of 200% to 350% may be used. The fire-retardant paint 230 may be applied by a spray method.

The fire-retardant paint 230 may be applied after coating a primer of about 10 μm to 20 μm for adhesion.

Meanwhile, an interference-preventing gap G may be provided between the bottom surface of the partition wall 220 and the upper surface of the battery module 10. That is, the bottom surface of the partition wall 220 may be spaced apart from the upper surface of the battery module 10 by the interference-preventing gap G without contacting the upper surface of the battery module 10.

The interference-preventing gap G corresponds to a minimum gap for preventing the partition wall 220 and the battery module 10 from interfering with each other by vibration or impact when a vehicle is driven, and in the exemplary embodiment, the interference-preventing gap G may be designed in a range of about 2.0 mm to 3.0 mm. Accordingly, it is possible to prevent the partition wall 220 from being damaged by interference with the battery module 10.

In the exemplary embodiment, an expanded graphite sheet 240 may be further attached to the bottom surface of the partition wall 220. The expanded graphite sheet 240 may be attached to the bottom surface of the partition wall 220 through a double-sided tape or an adhesive.

The expanded graphite sheet 240 may be an expanded graphite sheet 240 having the characteristics of an expansion start temperature of 180° C. and an expansion rate (foaming rate) of 200% to 350%. When the expansion rate is less than 200%, a flame may leak out due to insufficient filling of the interference-preventing gap G, resulting in a flame spreading problem. In addition, when the expansion rate exceeds 350%, a structural change is given to the partition wall 220 due to excessive expansion, so that a flame may leak out or the battery module 10 may be pressurized to cause additional thermal runaway.

In the exemplary embodiment, a thickness L in the height direction of the expanded graphite sheet 240 may be set to a thickness L of a half of the interference-preventing gap G. For example, the thickness L may be designed in a range of 1.0 mm to 1.5 mm.

FIG. 7 illustrates a battery system provided with a partition wall according to another exemplary embodiment of the present disclosure.

The configuration of a battery system 2 according to the exemplary embodiment shown in FIG. 7 is substantially the same as that of the battery system 1 according to the exemplary embodiment shown in FIG. 6. However, in the case of the battery system 2 shown in FIG. 7, the structure of a partition wall 220′ is different from the partition wall 220 of the battery system 1 shown in FIG. 6.

Specifically, the partition wall 220′ shown in FIG. 7 is manufactured and assembled separately from the cover 210 rather than integrally, whereas the partition wall 220 shown in FIG. 6 is insert-molded into the cover 210 to be provided in an integrated structure. Hereinafter, the differences will be mainly described.

Referring to the drawing, the partition wall 220′ may be provided in a structure extending upward from an upper surface of the battery module 10 toward a bottom surface of the cover 210.

The partition wall 220′ may be provided with a locking hook 222 that is locked and fixed to a locking groove 11 provided in both side surfaces of the battery module 10 at the bottom end of the partition wall 220′, and a locking protrusion 223, which is placed on the upper surface of the battery module 10, at an upper part of the locking hook 222. In this case, the locking hook 222 and the locking protrusion 223 may be provided on an inner side surface of the partition wall 220′ facing both side surfaces of the battery module 10. In addition, both side surfaces of the battery module 10 may be both side surfaces on which the bus bar assembly 130 is disposed.

The partition wall 220′ may be assembled and fixed to the periphery of the upper surface of the battery module 10 by locking and fixing the locking hook 222 to the locking groove 11 of the battery module 10 in a state in which the locking protrusion 223 is placed on the upper surface of the battery module 10 and supported. In addition, the partition wall 220′ may be disposed in a structure extending above the upper surface of the battery module 10 toward the cover 210 from the upper side surface of each battery module 10.

When insert-molding of the partition wall 220 into the cover 210 is not easy, the partition wall 220′ may be manufactured as a separate configuration separated from the cover 210 and assembled to each battery module 10, and the partition wall 220′ may be disposed on the upper part of each battery module 10 in a closed-loop shape corresponding to the periphery of the upper surface edge of the corresponding battery module 10.

In the exemplary embodiment, the partition wall 220′ may be made of a flame-retardant material. The flame-retardant material may include, for example, a flame-retardant plastic containing 10 to 30% of glass fiber (GF) such as PP, MPPO, PA6, or the like. In addition, a fire-retardant paint 230 may be applied to an inner side surface and an upper surface of the partition wall 220′ including the locking protrusion 223. The fire-retardant paint 230 may include an epoxy-based intumescent flame-retardant paint. Since the characteristics of the partition wall 220′ and the fire-retardant paint 230 are the same as those of the above-described exemplary embodiment of FIG. 6, a description thereof will be omitted.

An interference-preventing gap G may be provided between the upper surface of the partition wall 220′ and the bottom surface of the cover 210. That is, the upper surface of the partition wall 220′ may be spaced apart from the bottom surface of the cover 210 by the interference-preventing gap G without contacting the bottom surface of the cover 210.

This interference-preventing gap G corresponds to a minimum gap for preventing the partition wall 220′ and the battery module 10 from interfering with each other by vibration or impact when a vehicle is driven, and in the exemplary embodiment, the interference-preventing gap G may be designed in a range of about 2.0 mm to 3.0 mm. Accordingly, it is possible to prevent the partition wall 220′ from being damaged by interference with the battery module 10.

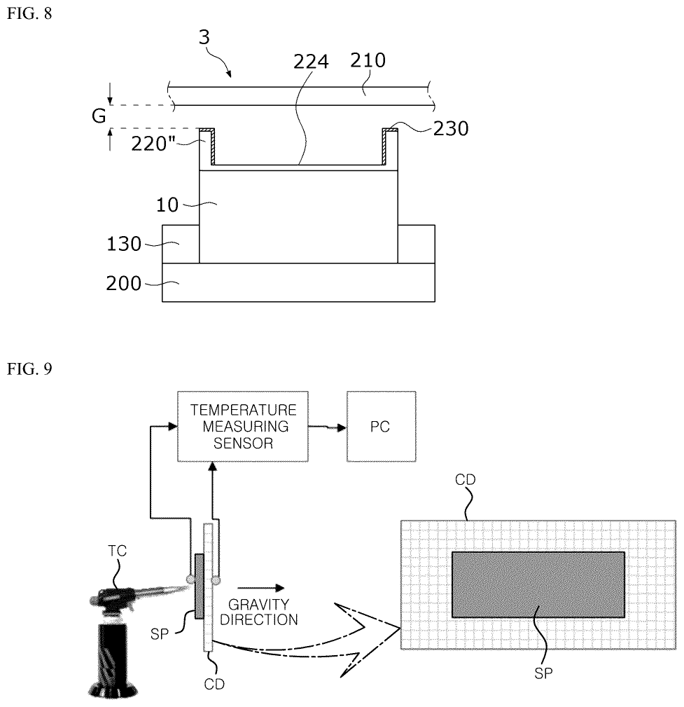

FIG. 8 illustrates another exemplary embodiment of a partition wall 220″.

Referring to the drawing, the partition wall 220″ may include a base 224 placed on an upper surface of each battery module 10, and may be provided in a structure extending upward from the periphery of an edge of the base 224.

The partition wall 220″ may be disposed in a structure extending above the upper surface of the battery module 10 toward the cover 210 from the periphery of the upper surface edge of each battery module 10 in a state in which the base 224 is attached and fixed to the upper surface of the battery module 10.

The partition wall 220″ and the base 224 may be made of a flame-retardant plastic. In addition, a fire-retardant paint 230 may be applied to an inner side surface and an upper surface of the partition wall 220″. The fire-retardant paint 230 may include an epoxy-based intumescent flame-retardant paint. Since the characteristics of the partition wall 220″ and the fire-retardant paint 230 are the same as those of the above-described exemplary embodiment of FIG. 6, a description thereof will be omitted.

An interference-preventing gap G may be provided between the upper surface of the partition wall 220″ and the bottom surface of the cover 210. That is, the upper surface of the partition wall 220″ may be spaced apart from the bottom surface of the cover 210 by the interference-preventing gap G without contacting the bottom surface of the cover 210.

Meanwhile, in this exemplary embodiment, the base 224 is described as being attached to the upper surface of the battery module 10, but the base 224 may be used as the module cover 120 that covers the upper part of the stacked structure 100 in the battery module 10.

That is, the conventional module cover 120 made of a lightweight plastic may be omitted, and the base 224 made of a flame-retardant plastic may be used as the module cover 120. In this case, the battery module 10 has a structure in which the partition wall 220″ is integrated with the base 224 replacing the module cover, and thus a separate process for assembling the partition wall 220″ to the battery module 10 may be omitted, thereby reducing manufacturing time and cost.

FIG. 9 illustrates a method of confirming the flame suppression ability according to a material of the partition wall. FIG. 9 is a configuration diagram illustrating a method of performing a flame test on the partition wall.

In the test, a specimen SP was prepared for each material, and fixed to a cradle CD in which a mesh window was formed, and a flame torch TC was placed in front of the specimen SP in a state in which a fire-retardant paint was applied to the front surface of the specimen SP and a flame was implemented to heat the specimen SP to a temperature of about 1200° C.

The flame test was carried out for about 5 minutes, and data measured through a temperature measuring sensor disposed on the front surface of the specimen SP and the rear surface of the cradle CD was transmitted to a computer PC to confirm whether the required performance was satisfied. In this case, it was set to satisfy the required performance when the temperature at the rear surface was maintained at 200° C. or less.

As a result of the test, when the thickness of the partition wall made of PP-GF30 (containing 30% of GF) was 2.0 mm and the thickness of a fire-retardant paint was 200 μm, the flame suppression time was confirmed to be approximately 5 minutes and 30 seconds, and the temperature at the rear surface on the opposite side was confirmed to be 165° C., confirming that it was an optimal condition in consideration of weight and material costs.

As described above, according to the exemplary embodiments of the present disclosure, when a flame is generated in any one of the battery modules 10, it is possible to safely protect passengers by preventing the flame from spreading to other adjacent battery modules 10 by disposing the partition wall 220 implementing a fire wall function in the space between the battery module 10 and the cover 210 of the housing 20.

In particular, there is an advantage in that an expensive sensor or a separate complex and heavy device, such as a fire extinguisher, for conventional flame suppression is not required.

According to an exemplary embodiment of the present disclosure, a housing for a battery system that can prevent a fire from spreading in a battery module unit in a battery system equipped with a plurality of battery modules, and a battery system including the same can be provided.

It should be noted that the effects of the present disclosure are not limited to the above-described effect, and other effects not mentioned will be clearly understood to those skilled in the art from the following descriptions.

Although the exemplary embodiments of the present disclosure have been described, it will be understood by those skilled in the art that the present disclosure may be variously modified and changed within the spirit and scope of the present disclosure described in the following patent claims. In addition, differences related to such modifications and changes should be construed as being included in the scope of the present disclosure defined in the appended claims.

What is claimed is:

1. A battery system housing, comprising:
a case in which a plurality of battery modules are arranged and fixed and configured to have an open upper part;
a cover configured to cover the open upper part of the case; and
a partition wall disposed between the cover and the plurality of battery modules, and configured to block a flame generated in any one of the plurality of battery modules from spreading to other adjacent battery modules.

2. The housing of claim 1, wherein the partition wall is provided in a structure extending downward from a bottom surface of the cover toward upper surfaces of the plurality of battery modules.

3. The housing of claim 2, wherein the partition wall is configured to have a lattice-shaped structure corresponding to an arrangement of the plurality of battery modules arranged in a horizontal direction and a vertical direction, and is disposed in a closed-loop shape corresponding to a periphery of an upper surface edge of a corresponding battery module, on an upper part of each battery module of the plurality of battery modules.

4. The housing of claim 2, further comprising an interference-preventing gap provided between a bottom surface of the partition wall and the upper surfaces of the plurality of battery modules.

5. The housing of claim 2, wherein the partition wall is insert-molded on the bottom surface of the cover to be provided in an integrated structure.

6. The housing of claim 1, wherein the partition wall comprises flame-retardant plastic, and
wherein the housing further comprises an expanded graphite sheet attached to a bottom surface of the partition wall.

7. The housing of claim 6, wherein a fire-retardant paint is applied to an inner side surface of the partition wall.

8. The housing of claim 1, wherein the partition wall is provided in a structure extending upward from upper surfaces of each of the plurality of battery modules toward a bottom surface of the cover.

9. The housing of claim 8, wherein the partition wall further comprises:
a base disposed on the upper surfaces of each of the plurality of battery modules, and is disposed in a structure extending upward from a periphery of an edge of the base,
wherein the partition wall and the base comprise a flame-retardant plastic.

10. The housing of claim 8, wherein the partition wall comprises:
a locking hook, which is locked and fixed to a locking groove provided in a side surface of each of the plurality of battery modules at a bottom end of the partition wall; and
a locking protrusion, which is placed on the upper surfaces of each of the plurality of battery modules, at an upper part of the locking hook, and is disposed in a structure extending above the upper surface of the battery module from an upper side surface of the battery module.

11. The housing of claim 10, wherein a fire-retardant paint is applied to an inner side surface of the partition wall and an upper surface of the partition wall.

12. The housing of claim 8, wherein an interference-preventing gap is provided between an upper surface of the partition wall and the bottom surface of the cover.

13. The housing of claim 1, wherein the partition wall comprises a flame-retardant plastic having a char (bubble-shaped carbide) production amount of 10 to 40%.

14. A battery system, comprising:
a plurality of battery modules; and
a housing comprising a case having an open upper part and configured to accommodate the plurality of battery modules, a cover configured to cover the open upper part of the case, and a partition wall disposed between the cover and the plurality of battery modules,
wherein the partition wall is configured to block a flame generated in any one of the plurality of battery modules from spreading to other adjacent battery modules.
